(19) United States
(12) Patent Application Publication
(10) Pub. No.: US 2024/0376246 A1
(43) Pub. Date: Nov. 14, 2024

(54) ONE-POT PROCESS FOR THE PRODUCTION OF POLYCARBODIIMIDE CURED POLYMERS

(71) Applicant: BASF SE, Ludwigshafen am Rhein (DE)

(72) Inventors: Xiao Yu SUN, Shanghai (CN); Dong LIANG, Shanghai (CN); Chang Xi LI, Shanghai (CN); Hai Sheng WU, Shanghai (CN); Li Chao ZHU, Shanghai (CN); Jia Yue HUANG, Shanghai (CN); Zhi Zhong CAI, Shanghai (CN)

(21) Appl. No.: 18/691,926

(22) PCT Filed: Sep. 9, 2022
(86) PCT No.: PCT/EP2022/075159

§ 371 Date: Mar. 14, 2024

(30) Foreign Application Priority Data
Sep. 17, 2021 (WO) PCT/CN2021/119070

(51) Int. Cl. C08G 18/02; C08G 18/20; C08G 18/32; C08G 18/48

(52) U.S. Cl. CPC C08G 18/025; C08G 18/2018; C08G 18/3206; C08G 18/3218; C08G 18/4854; C08G 2115/06

(57) ABSTRACT

The present invention relates to a one-pot process for the production of poly carbodiimide cured polymers. comprising a reaction of (a) at least one polycarbodiimide with two or more carbodiimide functionalities per molecule. (b) at least one polyol with two or more hydroxyl functionalities per molecule, and (c) at least one cyclic carboxylic anhydride.

The present invention relates to a one-pot process for the production of polycarbodiimide cured polymers.

### BACKGROUND

Polyurethane process has been used to produce polymers, particularly elastic or rigid polymers. In such a process, a polyisocyanate with two or more isocyanate groups on each molecule is reacted with a polyol with two or more hydroxyl groups on each molecule via polycondensation, forming a polymer of alternating polyisocyanate units or segments and polyol units or segments. Polyurethanes are used in the manufacture of high-resilience foams, rigid foams, microcellular foams, spray foams, etc. They are useful in the production of seating, insulation panels, seals and gaskets, durable elastomeric wheels and tires such as those for roller coasters, escalators, shopping carts, elevators, and skateboard, automotive suspension bushings, electrical potting compounds, high-performance adhesives, surface coatings and sealants, synthetic fibers, carpet underlay, hard-plastic parts such as those for electronic instruments, condoms, and hoses.

However, such a process is disadvantageous in that isocyanates are usually volatile and toxic. Isocyanates are classified as dangerous substances. All diisocyanates are very reactive chemicals that are potentially hazardous to humans. They are harmful by inhalation of vapors and aerosol mists, irritating to eyes, respiratory system, and skin, and some may cause sensitization by inhalation and skin contact. The potential for exposure depends on the vapor pressure. Monomeric and polymeric methylene diphenyl diisocyanate are labeled “harmful”. Toluene diisocyanate is labeled “very toxic”, and should be handled with care.

Special measures have been taken to overcome such disadvantage. For example, toluene diisocyanate and methylene diphenyl diisocyanate are often modified by partially reacting them with polyols or introducing other materials to reduce their volatility and toxicity. Such modifications also decrease their freezing points to make handling easier or to improve the properties of the final polymers. However, this also means additional effort and cost in the production of the final product.

Moreover, polyurethane is a combustible solid and can be ignited if exposed to an open flame, and produces carbon monoxide, hydrogen cyanide, nitrogen oxides, isocyanates, and other toxic products. It is therefore required to introduce flame retardants into the final product. However, many flame retardants are considered harmful as well.

Furthermore, such a process also suffers from bubbling issues caused by evolvement of volatile small molecules when polyurethane resin is heated. Under such situation, isocyanate reacts with H₂O, generating gaseous CO₂, which forms small bubble in the PU film. This creates visible defect in the final product, such as pin holes in polyurethane film.

As an alternative, polycarbodiimide is reacted with a polycarboxylic acid to produce elastic polymer. Such a process is advantageous in that polycarbodiimide is a non-toxic resin, and will not have any bubbling issue.

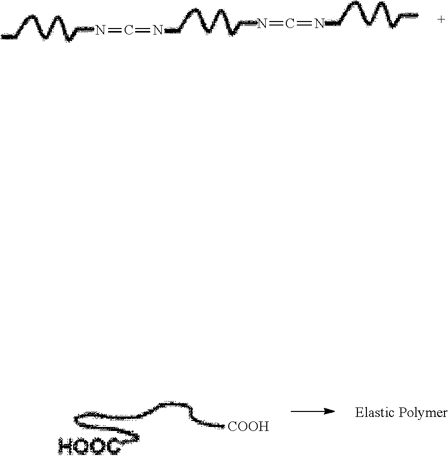

However, the reaction between carbodiimide groups and carboxylic acid groups proceeds very quickly and is difficult to control. In fact, the rapid reaction between carbodiimide and carboxylic acid is the very reason why carbodiimide can be used as acid scavenger and hydrolysis stabilizer for ester-based polymers, in which case it is desired to have a high reaction rate constant, as the concentration of acid and water can be very low.

The high reaction rate constant also limits the selection of polycarboxylic acid. Only those polycarboxylic acids with lower reaction activity can be used in order to slow down the reaction with polycarbodiimide merely for the sake of process control. The limited selection means that the properties of the product, such as elastic polymer, is also limited.

Furthermore, commercial availability for polycarboxylic acid is also limited. For example, while polytetrahydrofuran segment is useful in the preparation of elastic polymer, currently, there is no polytetrahydrofuran with two or more carboxylic acid functionalities commercially available. Although one can synthesize such polytetrahydrofuran, such synthesis and subsequent separation and purification render additional process steps, driving the cost for the final product higher.

Shifting from polyurethane chemistry (which generally involves polyisocyanates and polyols) to polycarbodiimide chemistry (which involves polycarbodiimide and polycarboxylic acid) is also disadvantageous in that the knowledge on polyurethane chemistry becomes less useful. For example, it is readily known that the properties of a polyurethane are greatly influenced by the types of isocyanates and polyols used in polyurethane production. In general, long, flexible segments, contributed by the polyol, give soft, elastic polymer; high amount of crosslinking gives tough or rigid polymers; long chains and low crosslinking give a polymer that is very stretchy, short chains with many crosslinks produce a hard polymer; while long chains and intermediate crosslinking give a polymer useful in making foam. Based on these, vast amount of knowledge has been accumulated on exactly how to tailor the properties of the final product to suite the actual need. However, without a polyol structure in the molecule, such knowledge becomes redundant.

Thus, there is a need to find a process to produce polymers, particularly elastic polymers, using the reaction of polycarbodiimide with polyol and cyclic carboxylic anhydride as alternative to the reaction of polycarbodiimide and polycarboxylic acid in order to ease the control of the reaction process and widen the selection of the segment derived from the polycarboxylic acid.

### SUMMARY

In the present invention, polycarbodiimide is reacted with polyol and cyclic carboxylic anhydride in a one-pot process. Furthermore, the reactants polycarbodiimide, polyol and cyclic carboxylic anhydride were preferably added to a reaction vessel in one portion at the beginning of the reaction.

The polyol and the cyclic carboxylic anhydride reactants can be selected from a wide range of materials, as the restriction of low reaction activity of the reactant can be satisfied by a wide range of polyol and cyclic carboxylic anhydride. The widening of the selection of the polyol and cyclic carboxylic anhydride also contributes to the availability of a wider range of properties of the produced polymer.

The reaction proceeds mildly and is easy to control.

The polycarbodiimide cured polymer produced by the inventive process is useful in adhesives, wood coatings and water-proof coatings.

### DETAILED DESCRIPTIONS

### Polycarbodiimide

The polycarbodiimide useful in the present invention can be any compound with two or more carbodiimide functionalities per molecule, such as polymeric polycarbodiimide, depends on the application of the final product. The polycarbodiimide is reactive to carboxylic acid group under the conditions applied in the present invention.

The polycarbodiimide useful in the present invention can be polymeric and monomeric. Polymeric polycarbodiimide can also be oligomeric. The term “oligomer” in the context of the present invention refers to a polymer with low degree of polymerization. For example, the degree of polymerization of the oligomeric polycarbodiimide can be 2 to 20, preferably 2 to 10, more preferably 2 to 5, or even 2 to 3.

In the case of polymeric polycarbodiimide, the carbodiimide functionalities can be present, for example, as repeating unit within the main chain of the polymer, and/or as end groups capping the polymer chain, and/or as pendent groups within the side chains attached to the main chain of the polymer.

The remaining structure in addition to the carbodiimide functionalities of the polycarbodiimide can be aliphatic, alicyclic, or aromatic, with aromatic structure being preferred.

Conventionally, carbodiimide functionalities can be derived, for example, from the condensation of two isocyanate groups in the presence of a catalyst with the elimination of a carbon dioxide molecule:

2-N═C═O→—N═C═N—+CO₂

The catalyst and the conditions for the reaction are known to those skilled in the art.

Furthermore, polycarbodiimide with carbodiimide functionalities within the main chain of the polymer can be obtained when polyisocyanate is polymerized.

n O═C═N—R—N═C═O→—(N═C═N—R)ₙ-+n CO₂

In the reaction scheme above, R can be any groups that is inert during the reaction. R is therefore preferably a divalent hydrocarbyl group having 1 to 20 carbon atoms, preferably selected from C₁-C₂₀ alkylene group, C₃-C₁₀ cycloalkylene group, C₂-C₂₀ alkenylene group, or C₆-C₁₆ arylene group, optionally substituted with at least one functional group selected from cyanato, isocyanato, halogen, amido, carboxamido, amino, imido, imino and silyl group.

In one embodiment of the present invention, R is a divalent hydrocarbyl group having 1 to 10 carbon atoms, preferably selected from C₁-C₁₀ alkylene group, C₄-C₇ cycloalkylene group, C₂-C₁₀ alkenylene group, or C₆-C₁₀ arylene group, optionally substituted with at least one functional group selected from cyanato, isocyanato, halogen, amido, carboxamido, amino, imido, imino and silyl group.

Therefore, the polycarbodiimide can be those prepared from the condensation of conventional polyisocyanate, which can be selected from the group consisting of toluene diisocyanate (TDI) and its isomers, monomeric methylene diphenyl diisocyanate (MDI) and its isomers, poly (methylene diphenyl diisocyanate) and its isomers, 1,5-naphthalene diisocyanate, tris(4-carbodiimidophenyl)methane, 1,6-hexamethylene diisocyanate, symmetrical and unsymmetrical trimer of 1,6-hexamethylene diisocyanate, isophorone diisocyanate, trimer of isophorone diisocyanate, and 1,1-methylenebis(4-diisocyanatocyclohexane). For example, in the case of 2,4-toluene diisocyanate, a polycarbodiimide can be synthesized according to the following reaction scheme:

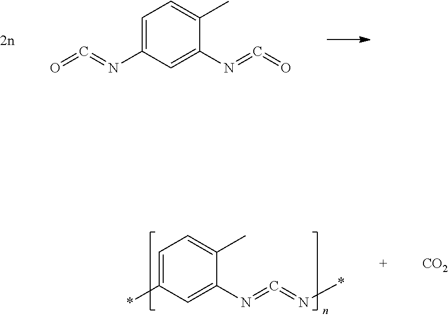

As described in CN106164123A, polycarbodiimide can also be prepared from a diisocyanate in the presence of a precursor compound and a carbodiimidization catalyst. Said precursor compound comprises a carbodiimide compound, a urethane compound, a thiourethane compound or a urea compound. For example, when the precursor compound comprises a carbodiimide compound, said carbodiimide can be diphenyl carbodiimide, which can be obtained from phenyl isocyanate:

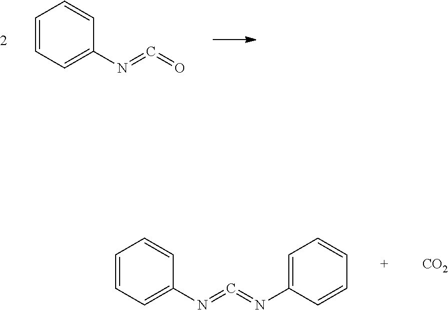 [SMILES: O=C=Nc1ccccc1 ; C(=Nc1ccccc1)=Nc1ccccc1 ; "CO2"]

The precursor compound end-caps the polycarbodiimide that is formed by polymerizing polyisocyanate so that the molecular weight and its distribution are regulated. For example, when a polycarbodiimide is prepared from 2,4-TDI in the presence of diphenyl carbodiimide, the polycarbodiimide will have the following structure:

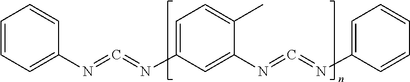

It is possible to use other types of compounds having two or more carbodiimide functionalities per molecule. For example, as described in CN107428902A, it is possible to use a polycarbodiimide-polyurethane hybrid. The polycarbodiimide-polyurethane hybrid can be prepared by partial carbodiimidization of toluene diisocyanate to isocyanate conversion of about 10%, followed by the reaction of polyol with carbodiimide group. Alternatively, it is also possible to react toluene diisocyanate with polyol to form polyisocyanate with excessive isocyanate group, followed by carbodiimidization of the isocyanate groups. An example of the polycarbodiimide-polyurethane hybrid is shown as following:

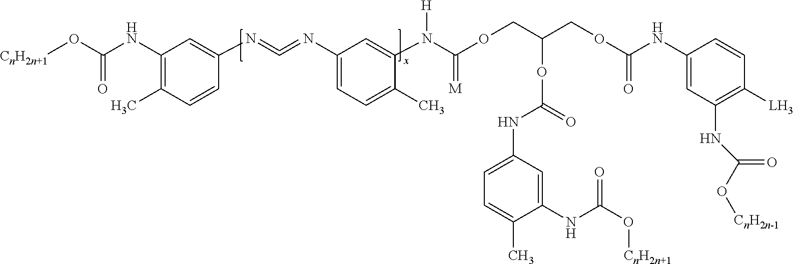

Therefore, the polycarbodiimide useful in the present invention comprise the structure represented by formula (I):

—[—N═C═N—R—]ₙ- (I)

wherein

R is a divalent hydrocarbyl group having 1 to 20 carbon atoms, preferably selected from C₁-C₂₀ alkylene group, C₃-C₁₀ cycloalkylene group, C₂-C₂₀ alkenylene group, or C₆-C₁₆ arylene group, optionally substituted with at least one functional group selected from cyanato, isocyanato, halogen, amido, carboxamido, amino, imido, imino and silyl group, and n is from 2 to 10, preferably from 2 to 8, more preferably from 2 to 6.

In one embodiment of the present invention, R is a divalent hydrocarbyl group having 1 to 10 carbon atoms, preferably selected from C₁-C₁₀ alkylene group, C₄-C₇ cycloalkylene group, C₂-C₁₀ alkenylene group, or C₆-C₁₀ arylene group, optionally substituted with at least one functional group selected from cyanato, isocyanato, halogen, amido, carboxamido, amino, imido, imino and silyl group.

It should be noted that R can be the same or different groups in one polycarbodiimide molecule. For example, when there exist two different R groups, formula (I) is be transformed into following formula (Ia):

—[—N═C═N—Rₐ—]ₐ-[—N═C═N—R_{b}—]_{b}- (Ia)

wherein Rₐ and R_{b} are different divalent hydrocarbyl groups each having 1 to 20 carbon atoms, preferably selected from C₁-C₂₀ alkylene group, C₃-C₁₀ cycloalkylene group, C₂-C₂₀ alkenylene group, or C₆-C₁₆ arylene group, optionally substituted with at least one functional group selected from cyanato, isocyanato, halogen, amido, carboxamido, amino, imido, imino and silyl group, and

a>0, b>0, a+b is from 2 to 10, preferably from 2 to 8, more preferably from 2 to 6.

The molecular weight of polymeric polycarbodiimide is not particularly limited. For example, the polycarbodiimide can be of the molecular weight of 250 to 5000, preferably 500 to 3000.

The polycarbodiimide useful in the present invention can be characterized by the content of NCN in the compound. In one embodiment of the present invention, the polycarbodiimide useful has a NCN content of 3-15% by mass, preferably 5-10% by mass.

The polycarbodiimide useful in the present invention is commercially available as, for example, Carbodilite SV-02, V-02-L2, V-02, E-02, E-03A from Nisshinbo Chemical Inc., Japan, or Baltanex W01 from BASF, Germany, or Stabaxol P-200 from Lanxess, Germany.

### Polyol

The polyol useful in the present invention can be any compound with two or more hydroxyl groups per molecule.

The polyol can be monomeric or polymeric. Polymeric polyol can also be oligomeric.

When the polyol is polymeric, the hydroxyl groups can be presented either as end groups of the polymer chain, or pendent groups as a part of side chains.

For example, the polyol can be any polyol conventionally used in the preparation of polyurethane, such as those selected from the group consisting of polyether polyol, polyester polyol, and monomeric polyol.

Molecular weight of the polymeric polyol, such as polyether polyol and polyester polyol, is not particularly limited. For example, the number average molecular weight of the polyether polyol and polyester polyol can be 200 to 10000, preferably of 1000 to 5000, more preferably 1500 to 3000.

Special polyols useful in the present invention can also be any other or particular polyols used in the preparation of polyurethanes, such as polycarbonate polyols, polycaprolactone polyols, polybutadiene polyols, and polysulfide polyols. These polyols, preparations and properties thereof, are known to those skilled in the art.

### Polyether Polyol

For one example, the polyol can be any polyether polyol derived from the reaction of an initiator, which is also referred to as a starter, and an alkylene oxide, which is also referred to as a cyclic ether.

The initiator is preferably a compound with at least two active hydrogen that can react with the alkylene oxide to form a polyether chain, and can be selected from the group consisting of monomeric polyols such as ethylene glycol, propylene glycol, dipropylene glycol, 1,2-butanediol, 1,3-butanediol, 1,4-butanediol, 1,2-pentanediol, 1,4-pentanediol, 1,5-pentanediol, 1,6-hexanediol, 1,7-heptanediol, butenediol, butynediol, xylene glycols, 1,4-phenylene-bis-beta-hydroxyethylether, 1,3-phenylene-bis-beta-hydroxyethylether, bis-(hydroxy-methyl-cyclohexane), thiodiglycol, glycerol, 1,1,1-trimethylolpropane, 1,1,1-trimethylolethane, 1,2,6-hexanetriol, alpha-methyl glucoside, pentaerythritol and sorbitol; amines such as aniline, o-chloroaniline, p-aminoaniline, 1,5-diaminonaphthalene, methylene dianiline, the condensation products of aniline and formaldehyde, 2,3-, 2,6-, 3,4-, 2,5-, and 2,4-diaminotoluene and isomeric mixtures, methylamine, triisopropanolamine, ethylenediamine, 1,3-diaminopropane, 1,3-diaminobutane, 1,4-diaminobutane, propylene diamine, butylene diamine, hexamethylene diamine, cyclohexalene diamine, phenylene diamine, tolylene diamine, xylylene diamine, 3,3′-dichlorobenzidine and 3,3′-dinitrobenzidine; alkanol amines such as ethanol amine, aminopropyl alcohol, 2,2-dimethyl propanol amine, 3-aminocyclohexyl alcohol, and p-aminobenzyl alcohol; and combinations thereof.

The alkylene oxide is preferably a cyclic compound that can form a polyether chain via ring opening polymerization, and can be selected from the group consisting of ethylene oxide, propylene oxide, butylene oxide, amylene oxide, tetrahydrofuran, mixture of tetrahydrofuran and other alkylene oxide, epihalohydrins, aralkylene oxides, and combinations thereof. More preferably, the alkylene oxide is selected from the group of ethylene oxide, propylene oxide, tetrahydrofuran and combinations thereof.

Polyether polyols are commercially available as, for example, Lupranol L2048 from BASF, Germany.

A particularly preferred polyether polyol is polytetrahydrofuran, also referred to as poly (tetramethylene ether) glycol, which can be prepared by the polymerization of tetrahydrofuran, and is widely used in high performance coating, wetting and elastomer applications. Polytetrahydrofuran is commercially available as PolyTHF from BASF, Germany.

Preferably, the polyether polyol has number average molecular weight of 200 to 10000, preferably of 1000 to 5000.

Preferably, the polyether polyol used in the present invention can be selected from polytetrahydrofuran, particularly those with number average molecular weight of 500 to 5000, preferably 1000 to 3000, particularly 2000.

Those skilled in the art will appreciate that it is also possible to prepare polyether polyols via other synthetic routes. For example, it is possible to produce polytetrahydrofuran by intramolecular condensation of 1,4-butanediol.

### Polyester Polyol

For another example, the polyol can be any polyester polyol derived from the polycondensation of a multi-functional carboxylic acid, preferably dicarboxylic acid, and a polyhydroxyl compound, preferably a glycol. The dicarboxylic acid is preferably an organic dicarboxylic acid having 2 to 12 carbon atoms, preferably an aliphatic dicarboxylic acid having 4 to 6 carbon atoms, such as one that is selected from the group consisting of succinic acid, glutaric acid, adipic acid, suberic acid, azelaic acid, sebacic acid, dodecanedioic acid, maleic acid, fumaric acid, phthalic acid, isophthalic acid, terephthalic acid and mixtures thereof. It is also possible to use a corresponding dicarboxylic acid derivative, such as a dicarboxylic acid ester of an alcohol having 1 to 4 carbon atoms, or an anhydride of the dicarboxylic acid. The glycol is preferably an aliphatic diol, an aromatic diol or a combination thereof, preferably having 2 to 8 carbon atoms, and more preferably having 2 to 6 carbon atoms, such as ethylene glycol, diethylene glycol, propylene glycol, dipropylene glycol, 1,2-butanediol, 1,3-butanediol, 1,4-butanediol, 1,2-pentanediol, 1,4-pentanediol, 1,5-pentanediol, 1,6-hexanediol, 1,7-heptanediol, butenediol, butynediol, xylylene glycols, amylene glycols, 1,4-phenylene-bis-beta-hydroxyethylether, 1,3-phenylene-bis-beta-hydroxyethylether, bis-(hydroxy-methyl-cyclohexane), bis (hydroxymethyl) cyclohexane.

The conditions (including the catalysts) for the preparation of the polyester polyols are known to those skilled in the art.

It is also possible to prepare polyester polyols via other synthetic routes. For example, it is possible to produce polyester polyols based on reclaimed raw materials by transesterification of recycled poly (ethylene terephthalate) or dimethyl terephthalate distillation bottoms with glycols such as diethylene glycol.

Preferably, the polyester polyol has number average molecular weight of 200 to 10000, preferably of 1000 to 5000.

Polyether polyols are commercially available as, for example, Lupraphen from BASF, Germany.

### Monomeric Polyol

The monomeric polyol can be any low molecular weight, polyhydric alcohol, such as those selected from the group consisting of C₂-C₂₀. preferably C₂-C₁₂ alkane diols, C₃-C₁₀ cycloalkane diols, and C₆-C₁₆ arylene diols. Preferably, the monomeric polyol can be selected from the group consisting of ethylene glycol, diethylene glycol, propylene glycol, dipropylene glycol, 1,2-butanediol, 1,3-butanediol, 1,4-butanediol, 1,2-pentanediol, 1,4-pentanediol, 1,5-pentanediol, 1,6-hexanediol, 1,7-heptanediol, butenediol, butynediol, xylylene glycols, amylene glycols, 1,4-phenylene-bis-beta-hydroxyethylether, 1,3-phenylene-bis-beta-hydroxyethylether and bis-(hydroxy-methyl-cyclohexane).

The monomeric polyol can also be low molecular weight, polyhydric alcohol with three or more hydroxyl functionalities. For example, such polyol can be selected from the group consisting of glycerol, trimethylolpropane, trimethylolethane, ditrimethylolpropane, pentaerythritol, dipentaerythritol, tripentaerythritol, etc.

### Cyclic Carboxylic Anhydride

The cyclic carboxylic anhydride useful in the present invention are those carboxylic anhydrides with the anhydride moiety as a part of the cyclic structure. It can be intramolecular dehydration product of any multifunctional carboxylic acid, although they can be, and usually are, prepared by various alternative routes known to those skilled in the art. For example, in addition to the dehydration of aqueous maleic acid solutions, maleic anhydride can be prepared by catalytic oxidation of benzene or C₄ hydrocarbons such as n-butane. For another example, in addition to the dehydration of aqueous succinic acid solutions, succinic anhydride can be prepared by hydrogenation of maleic anhydride. For a final example, o-phthalic anhydride is usually prepared by gas-phase oxidation of o-xylene or naphthalene.

The cyclic carboxylic anhydride useful in the present invention can be represented by the following formula (II),

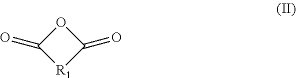

wherein R₁ is an alkylene group having 1 to 5 carbon atoms, an alkenylene group having 2 to 5 carbon atoms, a monocycloalkan-diyl group having 5 to 10 carbon atoms, a bicycloalkan-diyl group having 7 to 12 carbon atoms, a monocycloalken-diyl group having 5 to 10 carbon atoms, a bicycloalken-diyl group having 7 to 12 carbon atoms, a phenylene group, or an alkylene group of the formula —CH₂—(CH₂)ₙ₁-O—(CH₂)ₙ₂-CH₂—, wherein n1 and n2 is no less than 1 and n1+n2 is from 2 to 4, preferably an alkenylene group having 2 to 5 carbon atoms.

R₁ can be substituted with at least one functional group selected from cyanato, isocyanato, halogen, amido, carboxamido, amino, imido, imino and silyl group, preferably at least one halogen atoms.

Preferably, the cyclic carboxylic anhydride used in the present invention can be selected from the group consisting of o-phthalic anhydride, trimellitic anhydride, maleic anhydride, hexahydrophthalic anhydride, methylhexahydrophthalic anhydride, methyltetrahydrophthalic anhydride, tetrahydrophthalic anhydride, tetrachlorophthalic anhydride, pyromellitic dianhydride, himic anhydride, succinic anhydride, dodecenylsuccinic anhydride, chlorendic anhydride, and tetrabromophthalic anhydride.

Most preferably, the cyclic carboxylic anhydride is maleic anhydride and succinic anhydride, in particular maleic anhydride.

### Additives

The inventive process is preferably carried out in the presence of additives such as catalysts and chain extenders. It is certainly possible to apply any additional additives so as to achieve improvement on the physiochemical properties of the polymer produced from the inventive process.

### Catalyst

The inventive process is preferably carried out in the presence of catalysts which can be selected from the group consisting of Lewis acids and Lewis bases, as long as their presence do not cause significant side reactions.

The Lewis acid catalyst can be selected from the group consisting of metal halides such as zinc chloride, zinc bromide, tin (IV) halides, stannous chloride, stannous bromide, aluminum chloride, ferric chloride, boron chloride, boron trifluoride, antimony trichloride, antimony pentachloride, and mixtures thereof. The metal halide can also be used in the form of complexes such as etherate complexes and amine complexes, for example, boron trifluoride-piperidine and boron trifluoride-monoethylamine complexes. In such cases, the metal halide is believed to remain substantially inactive until released as by dissociation of the complex upon increasing the temperature.

The Lewis acid catalyst can also be selected from the group consisting of the salts of tin (IV) or tin (II) with C₁-C₁₂ carboxylic acids (such as octoic acid), dicarboxylic acids or aromatic carboxylic acids (such as substituted and unsubstituted benzoic and cinnamic acids), compounds having the formula Sb(OR)₃ where R is a C₁-C₁₂ alkyl group, e.g., tri-N-butyl antimonite, the compounds Ti(OR)₄ where R is a C₁-C₁₂ alkyl group, Al(OR)₃ where R is a C₁-C₁₂ alkyl group, dibutyl tin dichloride, butyl stannous oxide, and alike.

Lewis acid catalyst can also be selected from inorganic acids such as HCl, H₂SO₄, H₃PO₄, HF, HNO₃; organic carboxylic acids such as acetic acid, propionic acid, chloroacetic acid; and trialkylboranes such as trimethylborane, trietbylborane,

The Lewis base catalyst can be selected from the group consisting of methyl-, ethyl-, isopropyl- and octylamines, dimethyl-, diisoamyl-and diisobutylamines, methylethylamine, trimethyl-and triethylamines, methyldiethylamine, triisobutyl-and tridecylamines, 1,2-ethanediamine, 1,3-propanediamine, diethylenetriamine, triethylenetetraamine, tetraethylenepentaamine, n,n,n,n′-tetramethylethylenediamine, n-pentamethyldiethylenetriamine, p-phenylenediamine, o-toluidene, aniline, 1-naphthyl-and 2-naphthylamines, p-toluidine, benzylamine, diphenylamine, dimethylaniline, bis-(1,8)-dimethylaminonaphthalene, cyclohexylamine, dicyclohexylamine, piperidine and N-methylpiperidine, 3-phenylpiperidine, pyridine and 2-methylpyridine, 2,4,6-trimethylpyridine, 2-dodecylpyridine, 2-aminopyridine, 2-(dimethylamino) pyridine, quinoline, 2-(dimethylamino)-6-methoxyquinoline, pyrimidine, 1,8-phenanthroline, piperazine, N-methyl-and N-ethylpiperazines, 2,2′-bipyridyl and alkyl-substituted 2,2′-bipyridyls, 1,4-diazabicyclo [2.2.2] octane, hexamethylenetetraamine. purine, isopropanolamine, diethanolamine, di-N-propanalamine, triethanolamine, triisopropanolamine.

The Lewis base catalyst can also be selected from the group consisting of alkali metal or alkaline earth metal alkoxides such as lithium or sodium, barium, strontium alkanolates, or aluminum lower alkanolates, alkali metal cyanides such as potassium cyanide, strong quaternary ammonium hydroxides such as benzyltrimethyl ammonium hydroxide.

The most preferred catalysts can be exemplified by titanium butoxide, which is also referred to as tetrabutyl titanate, DABCO 33LV, which is 1,4-diazabicyclo [2.2.2] octane solution of triethylenediamine in dipropylene glycol available from Evonik, Germany, DBU, which is 1,8-diazabicyclo [5.4.0]undec-7-ene, and DMAP, which is 4-(dimethylamino) pyridine.

### Chain Extender

Chain extenders can be present in the inventive process in order to join polymer chains formed by the reaction of the polycarbodiimide, the polyol and the cyclic carboxylic anhydride, so as to modify mechanical properties of the final product. Chain extenders have two or more functional groups, preferably two functional groups, that react with reactive functional groups in the polymer chain, linking them together so that the molecular weight of the polymer is increased, for example doubled. The effect of the increase of molecular weight of the polymer is known to those skilled in the art. For example, typically, such increase in molecular weight will increase tensile strength of the polymer material.

The chain extender can be polyol, polyamine or polycarboxylic acid, preferably diol, diamine or dicarboxylic acid.

Polyol chain extenders can be any polyol, particularly diol, the hydroxyl groups of which react with carboxylic anhydride functional group first, and then with carbodiimide functional group. Polyol chain extender can be any diol, including those selected from the monomeric polyol listed above. Thus, preferred diol chain extender can be selected from the group consisting of C₂-C₂₀, preferably C₂-C₁₂ alkane diols, C₃-C₁₀ cycloalkane diols, and C₆-C₁₆ arylene diols, preferably selected from the group consisting of ethylene glycol, diethylene glycol, propylene glycol, dipropylene glycol, 1,2-butanediol, 1,3-butanediol, 1,4-butanediol, 1,2-pentanediol, 1,4-pentanediol, 1,5-pentanediol, 1,6-hexanediol, 1,7-heptanediol, butenediol, butynediol, xylylene glycols, amylene glycols, 1,4-phenylene-bis-beta-hydroxyethylether, 1,3-phenylene-bis-beta-hydroxyethylether and bis-(hydroxy-methyl-cyclohexane).

The chain extender can also be any polyamine, particularly diamine, the amine groups of which react with carbodiimide groups. Preferred diamine chain extenders can be selected from the group consisting of aromatic diamines such as 1-methyl-3,5-trimethyl-2,4-diamino benzene, 1-methyl-3,5-trimethyl-2,6-diamino benzene, 1,3,5-trimethyl-2,6-diamino benzene, or 3,5,3′,5′-tetramethyl-4,4′-diamino diphenyl methane, 2,2′,6,6′-tetraisopropyl-4,4′-methylenebisaniline; 1-methyl-3,5-diethyl-2,4-diaminobenzene; 1-methyl-3,5-diethyl-2,6-diaminobenzene; 1,3,5-triethyl-2,6-diaminobenzene, toluenediamines and alkylated toluenediamines such as 2,4-toluenediamine; 2,6-toluenediamine; 3,5-diethyl-2,4-diaminotoluene; 3,5-diethyl-2,6-diaminotoluene; 2,4,6-triethyl-m-phenylenediamine; 3,5-diisopropyl-2,4-diaminotoluene; 3,5-di-sec-butyl-2,6-diaminotoluene; 3-ethyl-5-isopropyl-2,4-diaminotoluene; 4,6-diisopropyl-m-phenylenediamine; 4,6-di-tert-butyl-m-phenylenediamine; 4,6-diethyl-m-phenylenediamine; 3-isopropyl-2,6-diaminotoluene; 5-isopropyl-2,4-diaminotoluene; 4-isopropyl-6-methyl-m-phenylenediamine; 4-isopropyl-6-tert-butyl-m-phenylenediamine; 4-ethyl-6-isopropyl-m-phenylenediamine; 4-methyl-6-tert-butyl-m-phenylenediamine; 4,6-di-sec-butyl-m-phenylenediamine; 4-ethyl-6-tertbutyl-m-phenylenediamine; 4-ethyl-6-sec-butyl-m-phenylenediamine; 4-ethyl-6-isobutyl-m-phenylenediamine; 4-isopropyl-6-isobutyl-m-phenylenediamine; 4-isopropyl-6-sec-butyl-m-phenylenediamine; 4-tert-butyl-6-isobutyl-m-phenylenediamine; 4-cyclopentyl-6-ethyl-m-phenylenediamine; 4-cyclohexyl-6-isopropyl-m-phenylenediamine; and 4,6-dicyclopentyl-m-phenylenediamine; and aliphatic or cycloaliphatic diamines such as N, N′-bis(t-butyl) ethylene diamine, cis-1,4-diamino cyclohexane, isophoronediamine, m-xylene diamine, 4,4′-methylene di-cyclohexylamine, methanediamine, or 1,4-diamino-methyl cyclohexane, 1,2-diaminocyclohexane, 1,3-diaminocyclohexane, 1,4-diaminocyclohexane, 2,4-diethyl-6-methyl-1,3-cyclohexanediamine, 4,6-diethyl-2-methyl-1,3-cyclohexanediamine, 1,3-cyclohexanebis(methylamine), 1,4-cyclohexanebis(methylamine), isophorone diamine, bis p-aminocyclohexyl)methane, bis(3-methyl-4-aminocyclohexyl)methane, 1,8-diamino-p-menthane, or 3(4),8(9)-bis-(aminomethyl)-tricyclo [5.2.1.0(2,6)]decane, N,N′-diisopropylethylenediamine, N,N′-di-sec-butyl-1,2-diaminopropane, N,N′-di(2-butenyl)-1,3-diaminopropane, N,N′-di(1-cyclopropylethyl)-1,5-diaminopentane, N, N′-di(3,3-dimethyl-2-butyl)-1,5-diamino-2-methylpentane, N, N′-di-sec-butyl-1,6-diaminohexane, N,N′-di(3-pentyl)-2,5-dimethyl-2,5-hexanediamine, N,N′-di(4-hexyl)-1,2-diaminocyclohexane, , N′-dicyclohexyl-1,3-diaminocyclohexane, N, N′-di(1-cyclobutylethyl)-1,4-diaminocyclohexane, N,N′-di(2,4-dimethyl-3-pentyl)-1,3-cyclohexanebis(methylamine), N,N′-di(1-penten-3-yl)-1,4-cyclohexanebis(methylamine), N,N′-diisopropyl-1,7-diaminoheptane, N,N′-di-sec-butyl-1,8-diaminooctane, N,N′-di(2-pentyl)-1,10-diaminodecane, N,N′-di(3-hexyl)-1,12-diaminododecane, N,N′-di(3-methyl-2-cyclohexenyl)-1,2-diaminopropane, N, N′-di(2,5-dimethylcyclopentyl)-1,4-diaminobutane, N, N′-di(isophoryl)-1,5-diaminopentane, N, N′-di(menthyl)-2,5-dimethyl-2,5-hexanediamine, N, N′-di(undecyl)-1,2-diaminocyclohexane, N, N′-di-2-(4-methylpentyl)-isophoronediamine, or N, N′-di(5-nonyl)-isophoronediamine.

The chain extender can also be any polycarboxylic acid, particularly dicarboxylic acid, the carboxylic acid groups of which react with carbodiimide groups. Preferred dicarboxylic acid chain extenders can be any dicarboxylic selected from the group consisting of aromatic dicarboxylic acid such as phthalic acid, isophthalic acid, terephthalic acid, 1,4-naphthalene dicarboxylic acid, 2,5-naphthalene dicarboxylic acid, 2,6-naphthalene dicarboxylic acid, biphenyl dicarboxylic acid, tetrahydro phthalic acid, and aliphatic dicarboxylic acid such as malonic acid, oxalic acid, tartaric acid, glutaric acid, adipic acid, pimelic acid, suberic acid, azelaic acid, sebacic acid, alkylsuccinic acid, linolenic acid, maleic acid and fumaric acid, mesaconic acid, citraconic acid and itaconic acid.

### Solvent

Due to the possible high viscosity of the reaction mixture, particularly caused by the high viscosity of the polyol, the inventive process is optionally carried out in the presence of a solvent. However, the presence of the solvent is less preferred as it may be necessary to remove the solvent from the polymer produced.

The solvent can be any compound that is non-reactive in the reaction system and is capable of dissolving the starting reactants. The solvent can be selected from conventional industrial solvents, for example, esters such as propylene carbonate, ethyl acetate or butyl acetate, a ketone such as acetone or butanone, an aliphatic hydrocarbon such as hexane, heptane or octane, and aromatic hydrocarbons such as benzene, toluene, p-xylene, o-xylene, m-xylene, and ethylbenzene.

The amount of the solvent can be determined by those skilled in the art according to actual need.

### Other Additives

Other additives can be added during the preparation of the polymer product. For example, surfactants may be added to modify the characteristics of both foam and non-foam polymers. The surfactant can be selected from those typically used in the preparation of polyurethane, such as polydimethylsiloxane-polyoxyalkylene block copolymers, silicone oils, nonylphenol ethoxylates, and other organic compounds. In foams, they are used to emulsify the liquid components, regulate cell size, and stabilize the cell structure to prevent collapse and sub-surface voids. In non-foam applications, they are used as air release and antifoaming agents, as wetting agents, and are used to eliminate surface defects such as pin holes, orange peel, and sink marks.

### Reaction Process and Conditions

The inventive process is a one-pot process, which refers to those reaction procedures in which substantially all the essential reactants are added to the reaction vessel at the beginning of the reaction procedure, preferably without removal of intermediate product or by-product from the reaction vessel before the completion of the reaction.

In the context of the present invention, the expression “essential reactants” denotes the polyol, the cyclic carboxylic anhydride and the polycarbodiimide which are used as reactants in the present invention. The expression “substantially all the essential reactants” means at least 60% by weight, preferably 75% by weight, more preferably 90% by weight, even more preferably 95% by weight, most preferably 100% by weight, of each of the essential reactants.

It should be noted that, in the context of the present invention, it is not necessary to add the additives, either listed above or not, to the reaction vessel at the beginning of the reaction procedure. For example, when the present invention is implemented in the presence of a catalyst, it is possible to either i) add all the catalyst to the reaction vessel at the beginning of the reaction procedure, or ii) add only a portion of the catalyst to the reaction vessel at the beginning of the reaction procedure and the remaining of the catalyst during the reaction, or iii) add all the catalyst to the reaction vessel during the reaction. In order to implement the inventive process, all the components of the reaction mixture, including the polycarbodiimide, the polyol, the cyclic carboxylic anhydride, the optional catalyst, the optional chain extender and the optional solvent are mixed in a proper reaction vessel. During such reaction, it is possible to add the optional solvent to facilitate mixing, taking into account of the high viscosity of the polyol.

Those skilled in the art will appreciate that it is possible to implement the present invention using more than one polycarbodiimide, polyol and/or cyclic carboxylic anhydride, respectively. In such case, they can be added either as a mixture or separately.

Preferably, the polyol and the cyclic carboxylic anhydride can be added to the reaction vessel at elevated temperature so as to form a homogenous mixture, followed by the addition of all the other chemicals, including the polycarbodiimide and additives such as the catalyst, at the beginning of the reaction process.

Preferably, the reaction is carried out in absence of the solvent.

The molar ratio of the carbodiimide functionality in the polycarboxydiimide, the hydroxyl functionality in polyol, and the cyclic carboxylic anhydride functionality in the cyclic carboxylic anhydride can be (1.2:1:1) to (1:1.2:1.2), preferably (1.1:1:1) to (1:1.1:1.1).

The amount of the catalyst can be determined by those skilled in the art according to actual need. Typically, the amount is of Lewis acid or Lewis base is about 0.01% to about 5% by weight, more preferably about 0.05 to about 2% by weight; most preferably about 0.1 to about 1% by weight, based on the total weight of the reaction mixture of the one-pot process of the present invention.

The amount of chain extender can be 1-20% by weight, preferably 1-5% by weight, based on the total weight of the reaction mixture of the one-pot process of the present invention.

The conditions for the reaction, such as temperature and reaction time can be selected by those skilled in the art according to actual need. In one embodiment of the invention, the reaction was carried out at elevated temperature and ambient pressure for a prolonged time. The actual temperature and duration of reaction can be determined by those skilled in the art according to actual need. For example, the reaction can be carried out at 25° C. to 150° C., preferably from 40° C. to 100° C.

It is also possible to carry out the reaction in stages under different conditions, such as temperature and reaction time. For example, the reaction can be carried out at 25° C. for 12 hours, and then at 70° C. for 3 days, or at 25° C. for 12 hours, and then at 120° C. for 3 days.

### Polymer Produced and Technical Advantage

As a polycarbodiimide-based process, the inventive process is inherently advantageous over polyurethane-based process in that it doesn't involve toxic isocyanate raw material and decomposition product.

Furthermore, those skilled in the art will appreciate that the property of the polymer produced depends on the selection of the polycarbodiimide, the polyol, and the cyclic carboxylic anhydride. Hence, the polymer produced can have a wide range of property, as the selection of the polycarbodiimide, the polyol, and the cyclic carboxylic anhydride can be made in a wider range.

The preset invention is also advantageous in that the reaction rate is moderate, so the reaction can be controlled easily.

The present invention is also advantageous in that the reaction of polycarbodiimide, polyol and cyclic carboxylic anhydride is carried out at lower temperature and avoids the use of special catalyst, while the reaction of polycarbodiimide and polyol is carried at high temperature and need special catalyst.

It should be noted that, as used in the specification and the appended claims, the singular forms “a,” “an” and “the” include both singular and plural referents unless the context clearly dictates otherwise. Thus, for example, reference to “a polycarbodiimide” includes one polycarbodiimide, mixtures of two or more of polycarbodiimides, and the like.

### EXAMPLES

### Raw Material

The following material was used in the examples.

### Polycarbodiimide

Baltanex W01: an aromatic polymeric carbodiimide available from BASF, Germany, with NCN %=6.33%

Stabaxol P-200: an aliphatic polymeric carbodiimide available from Lanxess, Germany, with NCN %=6.0%

### Polyol

PolyTHF2000: a polytetrahydrofuran polymer end-capped with two hydroxyl groups, with Mn of about 2000. PolyTHF2000 was obtained from BASF, Germany and was used as received.

Duranol T5651: a polycarbonate diol having 1,6-hexanediol and 1,5-pentanediol as diol components, having a hydroxyl value of 111 mgKOH/g, and a number average molecular weight of about 1000. DURANOL T5651 was obtained from Asahi Kasei Chemicals Corporation, Japan and was used as received.

PolyTHF650: a polytetrahydrofuran polymer end-capped with two hydroxyl groups, with Mn of about 650. The product was a liquid with a melting point of 11-19° C. PolyTHF650 was obtained from BASF, Germany and was used as received.

PolyTHF2900: a polytetrahydrofuran polymer end-capped with two hydroxyl groups, with Mn of about 2900. PolyTHF2900 was obtained from BASF, Germany and was used as received.

### Cyclic Carboxylic Anhydride

MA: maleic anhydride, with CAS Number 108-31-6, at a purity of 99%. MA was obtained from Sigma-Aldrich and was used as received.

### Catalyst

DMAP: 4-(dimethylamino) pyridine, with CAS Number 1122-58-3, at a purity of >99% by GC. DMAP was obtained from Signa-Aldrich and was used as received.

DABCO 33LV: 1,4-diazabicyclo [2.2.2]octane, which is a 33% by weight solution of triethylenediamine in dipropylene glycol. DABCO 33LV was obtained from Evonik, Germany and was used as received.

DBU: diazabicyclo [5.4.0]undec-7-ene, at a purity of 98%. DBU was obtained from Signa-Aldrich and was used as received.

### Chain Extender

BDO: 1,4-butanediol, CAS No.: 110-63-4, was obtained from BASF, Germany and was used as received.

### Measuring Methods

### Tensile Strength and Elongation at Break

Tensile strength and elongation at break are measured according to test standard DIN 53504 by using Zwick/Roell testing machine available from Zwick Roell Instrument & Technology Co, Ltd.

### Example 1

This example demonstrates the general process of the present invention, in which a polycarbodiimide, a polyether polyol and a cyclic carboxylic anhydride were reacted in a one-pot process.

To a 5 L reactor, the polyol and the cyclic carboxylic anhydride were added, heated to 75° C., and mixed with a SpeedMixer until the solid was completely dissolved. The polycarbodiimide and the catalyst were added and mixed further with the SpeedMixer at 1500 rpm for 2 minutes. The mixture was then poured into a mold and the surface was smoothened. The product was cured at room temperature for 12 hours, and then in an oven under specified conditions. The reactants and the amounts thereof, and the curing conditions are listed in Table 1.

The product obtained is a clear elastic polymer. Tensile strength and elongation at break of the produced elastic polymer were measured and the result is summarized in Table 1.

TABLE 1

| | | | | | Curing | Tensile | Elongation |
|---|---|---|---|---|---|---|---|
| | | Cyclic carboxylic | | | Temperature | strength | at break |
| No. | Polyol | acid anhydride | Polycarbodiimide | Catalyst | and time | (MPa) | (%) |
| 1.1 | PolyTHF2000 | maleic anhydride | Baltanex W01 | DMAP | 70° C. | 10.0 | 230 |
| | 2000.0 g | 206.0 g | 1327.0 g | 17.7 g | 3 days | | |
| 1.2 | PolyTHF2000 | maleic anhydride | Baltanex W01 | DMAP | 120° C. | 5.10 | 221 |
| | 2000.0 g | 206.0 g | 1327.0 g | 17.7 g | 3 days | | |
| 1.3 | PolyTHF2000 | maleic anhydride | Baltanex W01 | DABCO 33LV | 120° C. | 2.43 | 209 |
| | 2000.0 g | 206.0 g | 1327.0 g | 17.7 g | 3 days | | |

### Example 2

The example demonstrates the process of the present invention in the presence of a chain extender, in which a polycarbodiimide, a polyether polyol and a cyclic carboxylic anhydride were reacted in a one-pot process in the presence of a catalyst and a diol chain extender, and shows impact of chain extender on mechanical properties.

To a 5 L reactor, the polyol and the cyclic carboxylic anhydride were added, heated to 75° C., and mixed with a SpeedMixer until the solid was completely dissolved. The polycarbodiimide, the catalyst and the chain extender were added and mixed further at 1500 rpm for 2 minutes. The mixture was then poured into a mold and the surface is smoothened. The product was cured at room temperature for 12 hours, and then in an oven under the specified conditions. The reactants and the amounts thereof, and the curing conditions are listed in Table 2.

The product obtained is a clear elastic polymer. Tensile strength and elongation of the produced elastic polymer were measured and the result is summarized in Table 2. The result of example 1.3 above is also included in Table 2 as reference.

One can see that the presence of a chain extender at an increasing amount significantly improves tensile strength. In this particular example, elongation at break of the cured polymer is also increased.

TABLE 2

| | | | | | | Curing | Tensile | Elongation |
|---|---|---|---|---|---|---|---|---|
| | | Cyclic carboxylic | | Chain | | Temperature | strength | at break |
| No. | Polyol | acid anhydride | Polycarbodiimide | extender | Catalyst | and time | (MPa) | (%) |
| 1.3 | PolyTHF2000 | maleic anhydride | Baltanex W01 | | DABCO 33LV | 120° C. | 2.43 | 209 |
| | 2000.0 g | 206.0 g | 1327.0 g | | 17.7 g | 3 days | | |
| 2.1 | PolyTHF2000 | maleic anhydride | Baltanex W01 | BDO | DABCO 33LV | 120° C. | 2.98 | 227% |
| | 2000.0 g | 222.4 g | 1433.2 g | 7.2 g | 18.3 g | 3 days | | |
| 2.2 | PolyTHF2000 | maleic anhydride | Baltanex W01 | BDO | DABCO 33LV | 120° C. | 3.44 | 235% |
| | 2000.0 g | 226.5 g | 1459.7 g | 9.0 g | 18.4 g | 3 days | | |
| 2.3 | PolyTHF2000 | maleic anhydride | Baltanex W01 | BDO | DABCO 33LV | 120° C. | 4.65 | 240% |
| | 2000.0 g | 230.6 g | 1486.2 g | 10.8 | 18.6 g | 3 days | | |

### Example 3

The example demonstrates implementation of the process of the present invention using various polyol, including polyether polyol and polyester polyol.

The procedure of Example 2 was repeated except that the reactants and the amounts thereof and the specified conditions listed in Table 3 were used.

The product obtained is a clear elastic polymer. Tensile strength and elongation of the produced elastic polymer were measured and the result is summarized in Table 3.

One can see that the presence of a chain extender at an increasing amount significantly improves tensile strength. It is also clear that one can select the reactants such as polyol, and the chain extender and their respective amount in order to customize the physical properties of the polymer product to meet the requirement of various applications.

TABLE 3

| | | | | | | Curing | Tensile | Elongation |
|---|---|---|---|---|---|---|---|---|
| | | Cyclic carboxylic | | | Chain | Temperature | strength | at break |
| No. | Polyol | acid anhydride | Polycarbodiimide | Catalyst | extender | and time | (MPa) | (%) |
| 3.1 | DURANOL T5651 | maleic anhydride | Baltanex W01 | DBU | | 70° C., | 7.53 | 262% |
| | 1000.0 g | 206.0 g | 1327.0 g | 12.7 g | | 3 days | | |
| 3.2 | DURANOL T5651 | maleic anhydride | Baltanex W01 | DBU | BDO | 70° C., | 8.85 | 194% |
| | 1000.0 g | 215.8 g | 1390.7 g | 13.1 g | 4.3 g | 3 days | | |
| 3.3 | DURANOL T5651 | maleic anhydride | Baltanex W01 | DBU | BDO | 70° C., | 14.27 | 166% |
| | 1000.0 g | 236.4 g | 1523.4 g | 13.9 g | 13.3 g | 3 days | | |
| 3.4 | PolyTHF2000 | maleic anhydride | Baltanex W01 | DBU | BDO | 70° C., | 7.68 | 186% |
| | 2000.0 g | 222.4 g | 1433.2 g | 18.3 g | 7.2 g | 3 days | | |
| 3.5 | PolyTHF2000 | maleic anhydride | Baltanex W01 | DBU | BDO | 70° C., | 9.26 | 200% |
| | 2000.0 g | 230.6 g | 1486.2 g | 18.6 g | 10.8 g | 3 days | | |
| 3.6 | PolyTHF2000 | maleic anhydride | Baltanex W01 | DBU | BDO | 70° C., | 10.12 | 110% |
| | 2000.0 g | 247.1 g | 1592.4 g | 19.3 g | 18.0 g | 3 days | | |
| 3.7 | PolyTHF650 | maleic anhydride | Baltanex W01 | DBU | BDO | 70° C., | 12.61 | 94.3% |
| | 650.0 g | 247.1 g | 1592.4 g | 12.5 g | 18.0 g | 3 days | | |

### Example 4

The example demonstrates that the inventive one-pot processes can be implemented using both aromatic polymeric carbodiimide and aliphatic polymeric carbodiimide.

The procedure of Example 2 was repeated except that the reactants and the amounts thereof and the specified conditions listed in Table 4 were used. The product obtained is a clear elastic polymer. Tensile strength and elongation of the produced elastic polymer were measured and the result is summarized in Table 4.

The example clearly shows that the inventive one-pot process can be implemented using both aromatic polymeric carbodiimide and aliphatic polymeric carbodiimide, and the polymer obtained are similar in properties.

TABLE 4

| | | | | | | Curing | Tensile | Elongation |
|---|---|---|---|---|---|---|---|---|
| | | Cyclic carboxylic | | | Chain | Temperature | strength | at break |
| No. | Polyol | acid anhydride | Polycarbodiimide | Catalyst | extender | and time | (MPa) | (%) |
| 4.1 | PolyTHF2900 | maleic anhydride | Baltanex W01 | DMAP | BDO | 70° C., | 8.67 | 244.6 |
| | 1840.0 g | 496.3 g | 3198.0 g | 28.5 g | 160.0 g | 3 days | | |
| 4.2 | PolyTHF2900 | maleic anhydride | Stabaxol P-200 | DMAP | | 70° C., | 2.42 | 183.0 |
| | 2000.0 g | 142.0 g | 839.6 g | 14.9 g | | 3 days | | |

1.-17. (canceled)

18. A one-pot process for the production of a polycarbodiimide cured polymer, said process comprising a reaction of
(a) at least one polycarbodiimide with two or more carbodiimide functionalities per molecule,
(b) at least one polyol with two or more hydroxyl functionalities per molecule, and
(c) at least one cyclic carboxylic anhydride.

19. The process of claim 18, wherein said polycarbodiimide comprises the structure represented by formula (I):
—[—N═C═N—R—]ₙ- (I)
wherein
R is a divalent hydrocarbyl group having 1 to 20 carbon atoms, preferably selected from C₁-C₂₀ alkylene group, C₃-C₁₀ cycloalkylene group, C₂-C₂₀ alkenylene group, or C₆-C₁₆ arylene group, optionally substituted with at least one functional group selected from cyanato, isocyanato, halogen, amido, carboxamido, amino, imido, imino and silyl group, and
n is from 2 to 10;
wherein R is the same or different groups in one polycarbodiimide molecule.

20. The process of claim 18, wherein said polycarbodiimide comprises of the structure represented by formula (Ia):
—[—N═C═N—Rₐ—]ₐ-[—N═C═N—R_{b}—]_{b}— (Ia)
wherein Rₐ and R_{b} are different divalent hydrocarbyl groups each having 1 to 20 carbon atoms, preferably selected from C₁-C₂₀ alkylene group, C₃-C₁₀ cycloalkylene group, C₂-C₂₀ alkenylene group, or C₆-C₁₆ arylene group, optionally substituted with at least one functional group selected from the group consisting of cyanato, isocyanato, halogen, amido, carboxamido, amino, imido, imino and silyl group, and
a>0 b>0, a+b is from 2 to 10.

21. The process of claim 18, wherein the polycarbodiimide has a NCN content of 3-15% by mass.

22. The process of claim 18, wherein said polyol is selected from the group consisting of polyether polyol, polyester polyol and monomeric polyol.

23. The process of claim 22, wherein the polyether polyol and the polyester polyol have a number average molecular weight of 200 to 10000.

24. The process of claim 18, wherein said cyclic carboxylic anhydride is represented by formula (II) 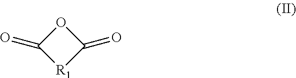
wherein
R₁ is an alkylene group having 1 to 5 carbon atoms, an alkenylene group having 2 to 5 carbon atoms, a monocycloalkan-diyl group having 5 to 10 carbon atoms, a bicycloalkan-diyl group having 7 to 12 carbon atoms, a monocycloalken-diyl group having 5 to 10 carbon atoms, a bicycloalken-diyl group having 7 to 12 carbon atoms, a phenylene group, or an alkylene group of the formula —CH₂—(CH₂)ₙ₁-O—(CH₂)ₙ₂-CH₂—, wherein n1 and n2 is no less than 1 and n1+n2 is from 2 to 4, optionally R₁ is substituted with at least one functional group selected from cyanato, isocyanato, halogen, amido, carboxamido, amino, imido, imino and silyl group.

25. The process of claim 18, wherein said cyclic carboxylic anhydride is selected from the group consisting of o-phthalic anhydride, trimellitic anhydride, maleic anhydride, hexahydrophthalic anhydride, methylhexahydrophthalic anhydride, methyltetrahydrophthalic anhydride, tetrahydrophthalic anhydride, tetrachlorophthalic anhydride, pyromellitic dianhydride, himic anhydride, succinic anhydride, dodecenylsuccinic anhydride, chlorendic anhydride, and tetrabromophthalic anhydride.

26. The process of claim 18, wherein the molar ratio of carbodiimide functionalities in the polycarbodiimide, hydroxyl functionalities in the polyol, and the cyclic carboxylic anhydride functionalities in the cyclic carboxylic anhydride is (1.2:1:1) to (1:1.2:1.2).

27. The process of claim 18, wherein said reaction is carried out in the presence of
(d) a catalyst selected from the group consisting of Lewis acid and Lewis base, and/or
(e) a chain extender with two or more functional groups, selected from hydroxyl group, and amino group and carboxylic acid group, and/or
(f) a solvent.

28. The process of claim 27, wherein said chain extender is selected from the group consisting of C₂-C₂₀ alkane diols, C₃-C₁₀ cycloalkane diols, and C₆-C₁₆ arylene diols.

29. The process of claim 27, wherein the catalyst is selected from the group consisting of titanium butoxide, DABCO 33LV, DBU and DMAP, and/or said chain extender is BDO.

30. The process of claim 18, wherein the reaction comprises following steps
(i) mixing the polycarbodiimide, the polyol, the cyclic carboxylic anhydride, the optional catalyst, the optional chain extender and the optional solvent together, forming a reaction mixture, preferably the polyol is mixed with the cyclic carboxylic anhydride first;
(ii) allowing the reaction to proceed to obtain polycarbodiimide cured polymer product.

31. The process of claim 30, wherein the reaction in step (ii) is carried out at 25° C. to 150° C.

32. The polycarbodiimide cured polymer obtained from the process of claim 18.

33. The polycarbodiimide cured polymer of claim 32, which is an elastic polymer.

34. The use of the polycarbodiimide cured polymer of claim 32 in adhesive, wood coatings, or water-proof coatings.
